(19) United States
(12) Patent Application Publication
(10) Pub. No.: US 2012/0001729 A1
(43) Pub. Date: Jan. 5, 2012

(54) METHOD AND DEVICE FOR STORAGE WITH ASSOCIATION OF VISUAL INDICATOR AND OBJECT SENSOR

(76) Inventor: Pedro Ernesto Gonçalves Guedes, Porto (PT)

(21) Appl. No.: 13/257,204

(22) PCT Filed: Dec. 9, 2009
(86) PCT No.: PCT/IB2009/055597

§ 371 Date: Sep. 16, 2011

(30) Foreign Application Priority Data
Apr. 9, 2009 (PT) 104498

(51) Int. Cl. G08B 5/22

(52) U.S. Cl. 340/8.1

(57) ABSTRACT

The current invention is related with the search, storage and collection of objects, more precisely of laboratory samples, more precisely blood tubes identified with barcodes. The current invention is useful for increasing the speed for finding a specific subject, without robotics or mechanical moving parts, thus allowing greater flexibility and simplicity of the system. The invention describes a storage with the combination of an array of sensors with an array of visual indicators, especially with light, coupled with a reader's identification of objects. The array of sensors detects when a sample is deposited or removed, and the array of indicators is used to indicate the location of the sample wanted. Thus, the present invention has application in the areas of laboratory sample storage, logistics and general health care.

This application is a U.S. national phase filing under 35 U.S.C.§371 of PCT Application No. PCT/IB2009/055597 filed Dec. 9, 2009, claiming priority under 35 U.S.C.§119 to Portuguese patent application No. 104498, filed Apr. 9, 2009, the entire disclosures of which are hereby incorporated by reference herein.

### FIELD OF INVENTION

The present invention relates to the storage, indexing, placement and collection of objects, particularly laboratory samples, by detecting the position used to store a given object and visual indication of where they should be collected and optionally for placing the object.

### BACKGROUND OF THE INVENTION

The implementation of the present invention can be related to the research laboratory samples, particularly blood tubes identified by barcode.

Thus the present invention is useful for increasing the speed of finding a specific tube. Can be applied in clinical laboratories for indexing tubes of blood and associate them to specific positions within the carrier also identified for further demand. It avoids the need for the use of robotic systems to solve the problem.

The clinical laboratories deals with hundreds of blood tubes identified by bar codes associated with different patients. This invention solves the problem that is the difficulty of finding a specific tube in the middle of hundreds.

The most common technique to solve this problem is through robotics. The Robot is responsible for arranging the tubes and also pick them as requested. These systems are very complex, expensive and difficult to configure.

The advantage of this invention over the existing, is the resolution of the problem without using robotics or mechanical moving parts, thus allowing greater flexibility and simplicity of the system.

The association of the array of sensors with the array of lights, combined with a reader's identification of objects, is one of the keys to the invention's originality.

The invention proposed here does not use robotics or mechanical moving parts. The technique consists of an array of sensors in conjunction with another array of visual indicators, including light emitting diodes, LEDs, working on tubes carrier. The array of sensors detects when a blood tube enters or exits, and the array of visual indicators is used to indicate the tube wanted.

### SUMMARY OF THE INVENTION

The present invention describes a storage system characterized by having at least an association of object sensor (2) and visual indicator (3); and by recording the location of an object when being stored thru the referenced object sensor, and by indicating the location of that object for its collection through this visual indicator.

An exemplary implementation of the present invention has the feature to have at least one level of storage (1) that locates the object to be stored through a combination of object sensor (2) and visual indicator (3), and to have one or more levels of storage that identifies the object to be stored for common identification (5).

Another exemplary implementation of the present invention has the characteristics of: store the objects in multiple units (1), each unit featuring multiple locations; Identify the object to be stored with common identification (5),

Recording the location of an object to be stored through the presence sensor (2), and indicate the location of that object for its collection through the visual indicator (3).

One other exemplary implementation of the present invention has the characteristic of the object sensor being an infrared photodiode or a mechanical switch.

Another exemplary implementation of the present invention has the characteristic of a common identification (5) be performed by liner barcode or two-dimensional barcode, or identification by radio frequency, or optical character recognition, or by manually entering an ID code.

Another exemplary implementation of the present invention has the characteristic of those units (1) having: a communication device or wireless to a data processor (4) for operation of the system, visual indicators through light-emitting diodes (3), object sensors using infrared photodiodes (2), and power supply device.

An exemplary implementation of the present invention has the characteristic of those units (1) have carriers for objects to be stored and the lights are placed adjacent to those objects, and those carriers are transparent or translucent, if the objects themselves are not enough transparent so the light could be visible.

Another implementation of the present invention has the feature to record the exchange of location of an object when collected and stored in different locations through the inverse activation of the object sensors (2).

An implementation of the present invention has the characteristic of the object sensors (2) and the visual indicators (3) being organized in a matrix of rows and columns

The present invention has application in laboratory storage of items, in particular, laboratory samples, test tubes, Petri dishes, microscope plates.

The present invention also has application in the storage of documents, in particular, documents placed in envelopes.

The present invention has the advantages of allowing objects to be collected and stored in a practical and fast manner without the use of robotics or mechanical moving parts, thus allowing greater flexibility and simplicity.

### BRIEF DESCRIPTION OF FIGURES

For an easier understanding of the invention, some figures are attached, which represent exemplary realizations of the invention, which, however, are not intended to limit the scope of this invention.

FIG. 1: Schematic representation of a unit (1), showing a sensor array (2) and light array (3).

FIG. 2: Schematic representation of a unit (1), showing the data processor (4) and a traditional identification reader (5).

FIG. 3: Schematic representation of the location method, and collection method of an object.

FIG. 4: Schematic representation of the method to store an object.

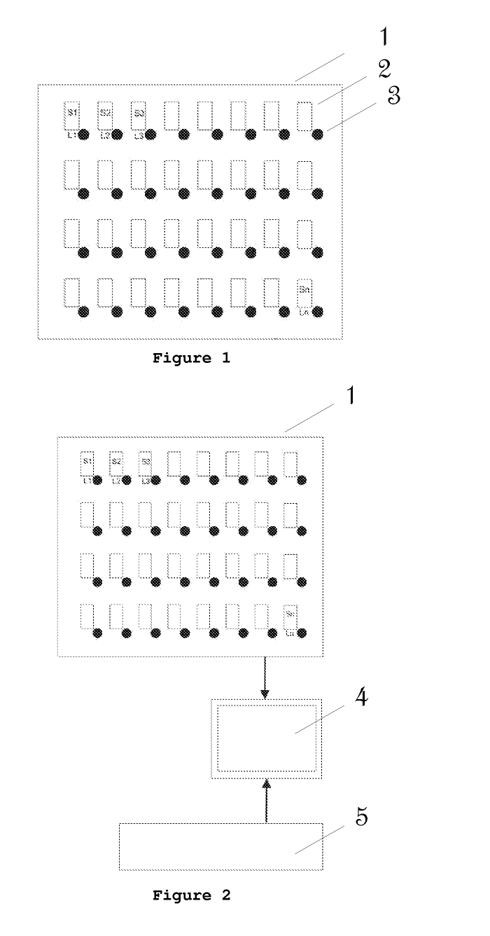

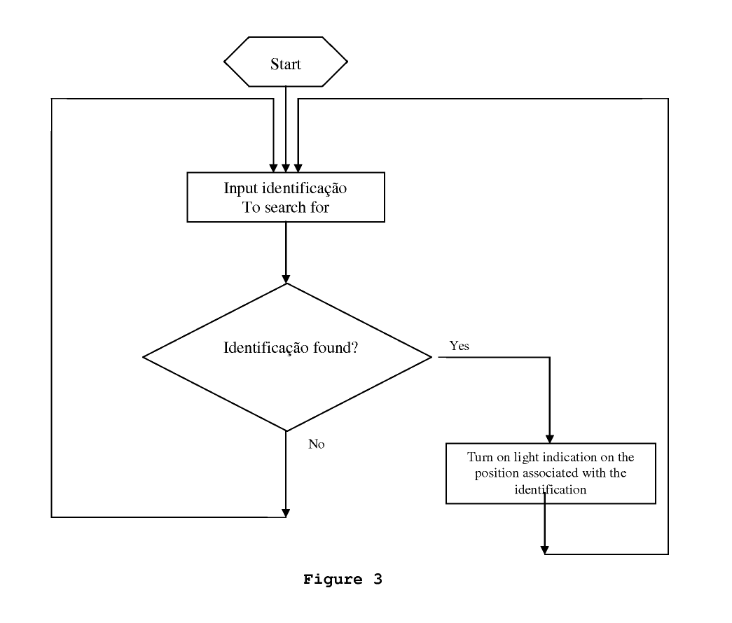

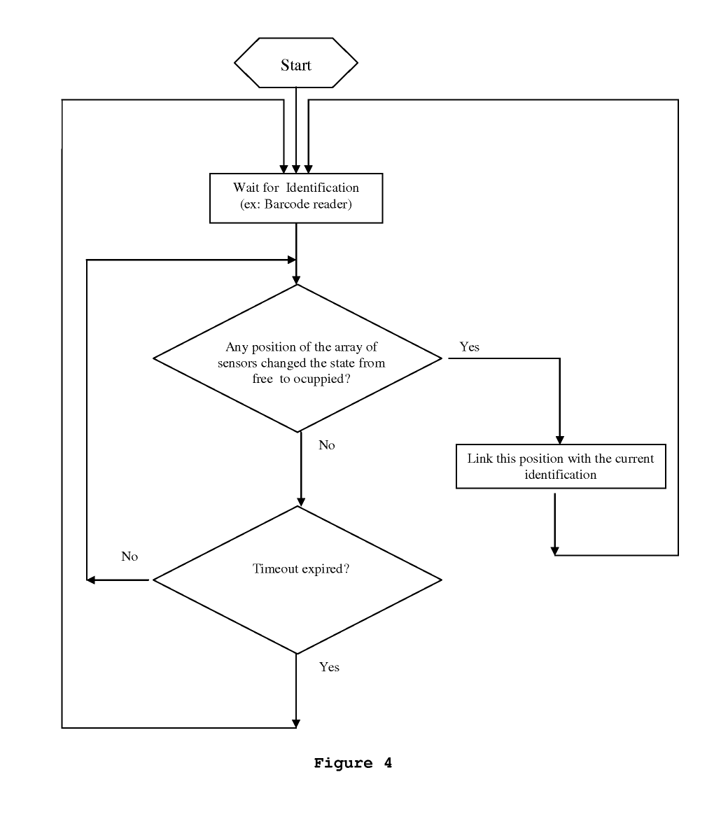

### GENERAL DESCRIPTION OF THE INVENTION

The present invention relates to the storage, indexing, placement and collection of goods, particularly laboratory samples, by detecting the position used to store a given object and visual indication of where they should be collected or optionally placed.

The technique consists of an array of sensors in conjunction with another array of visual indicators that work on a carrier for objects. The array of sensors detects when an object enters or exits, and the array of visual indicators is used to indicate the location of the object wanted.

Another exemplary implementation is the storage of laboratory samples, test tubes in particular.

In this implementation, the tubes are placed in a unit which has an array of sensors and an array of visual indicators, in this case light (LED—light emitting diode). The array of sensors detects the placement of a tube (previously identified) in a given location and the association between the identification and location is recorded. To collect a tube, simply activate the indicator light corresponding to the tube wanted.

In another exemplary implementation, we have multiple units with carriers that can be identified by a standard method such as bar code or OCR (optical character recognition, optical character recognition) or RFID (radio frequency identification), or the very same way before, the presence of visual indicators in each unit and the detection sensors, which was the unit on which the tube was placed.

This procedure can be used in multiple levels of storage. For example, in a warehouse, the location of an object can be visually displayed, at distance and height of the shelf, the board and even the location within each tray or carrier.

It's a flexible technique that can be combined easily with the usual techniques of identification. In fact, assigning the identification at a given structured storage level is always possible with barcode or RFID.

It is the combination of two techniques—a combination of visual indicator and object sensor with an usual method of identification—which gives the highest efficiencies and cost saves.

When, due to issues of density or size, the traditional identification systems show higher limitations, the present invention allows even greater gains, such as, for example, the case of blood tubes.

In a further exemplary implementation, we used units with electronic devices of the arrays mentioned above. On these units are placed carriers, for example, of 90 tubes each. These carriers are identified by “RFID” labels to support the unique identification.

More units can be added depending of the laboratory needs.

For example, if a laboratory works with 450 tubes per day, then it will need at least five (450/90) units.

In addition to the systematic search of the tubes every day, this system organizes the long storage of samples. Most of Laboratories have storage of samples for long periods, but without effective systems for managing them.

Because the carriers of the tubes have Identification, for instance with unique “RFID”, the computer software keeps track of the history of all tubes and carriers that have been read with this system.

The identification of the tubes is made, for instance, manually in a common barcode reader and the tube is placed by the user on any hole of any carrier (which is on a unit).

When the computer software detects a new barcode identification, it waits for a sensor to change from free to occupied. When this happens, the identification is linked with the position detected in the carrier affected.

1. Storage method for objects in multiple units, each unit featuring multiple locations, wherein said units receive carriers placed upon them, for the placement of said objects, comprising the following steps for receiving an object:
a) identify the object being stored by common identification,
b) identify the carrier being used by common identification,
c) register the location and the carrier being used by a presence sensor, of a plurality comprised in the unit, one for each storage location, when the object is placed in one of those locations.

2. Storage method according to claim 1 further comprising the following steps for retrieving a previously stored object:
a) keep track of the location of that object in each unit and carrier,
b) indicate the location of that object for its collection through a visual indicator.

3. Storage method according to claim 1 further comprising the step of registering the change of location of an object to be collected and stored in different locations through the deferred and opposite activation of object sensors.

4. Storage method according to claim 1 wherein the common identification is performed by one or two-dimensional barcode, or identification by radio frequency, or optical character recognition, or by manually entering an ID code.

5. Storage device suitable for performing the process of claim 1 comprising:
a) multiple units, each unit featuring multiple locations to store objects;
b) carriers placed upon said units, for the placement of said objects;
c) an identifier in each carrier and a carrier identifier reader;
c) an identifier in each object and an object identifier reader;
d) one or more pairs of a presence sensor and a visual indicator, each pair corresponding to a storage location.

6. Storage device according to claim 5 wherein the visual indicators are light emitters and the carriers are transparent or translucent able to transmit.

7. Storage device according to claim 6 wherein the object sensor is an infrared photodiode or a mechanical switch.

8. Storage device according to claim 7 wherein the units comprising: a communication device or wireless to a data processor for operation of the system, visual indicators through light-emitting diodes, object sensors using infrared photodiodes, and power supply.

9. Storage device according to claim 8 wherein the object sensors and the visual indicators are arranged in a matrix of rows and columns.

10. Storage device according to claim 9 wherein the object to store includes laboratory items, laboratory samples, test tubes, Petri dishes, microscope plates.

11. Storage device according to claim 10 wherein the object to be stored is documents, in particular, documents placed in envelopes.

12. Storage device according to claim 5 wherein the object sensor is an infrared photodiode or a mechanical switch.

13. Storage device according to claim 5 wherein the units comprising: a communication device or wireless to a data processor for operation of the system, visual indicators through light-emitting diodes, object sensors using infrared photodiodes, and power supply.

14. Storage device according to claim 5 wherein the object sensors and the visual indicators are arranged in a matrix of rows and columns.

15. Storage device according to claim 5 wherein the object to store includes laboratory items, laboratory samples, test tubes, Petri dishes, microscope plates.

16. Storage device according to claim 5 wherein the object to be stored is documents, in particular, documents placed in envelopes.

17. Storage method according to claim 2 further comprising the step of registering the change of location of an object to be collected and stored in different locations through the deferred and opposite activation of object sensors.

18. Storage method according to claim 2 wherein the common identification is performed by one or two-dimensional barcode, or identification by radio frequency, or optical character recognition, or by manually entering an ID code.

19. Storage device suitable for performing the process of claim 2 comprising:
a) multiple units, each unit featuring multiple locations to store objects;
b) carriers placed upon said units, for the placement of said objects;
c) an identifier in each carrier and a carrier identifier reader;
c) an identifier in each object and an object identifier reader;
d) one or more pairs of a presence sensor and a visual indicator, each pair corresponding to a storage location.
